(19) United States
(12) Patent Application Publication
(10) Pub. No.: US 2014/0092355 A1
(43) Pub. Date: Apr. 3, 2014

(54) LIQUID CRYSTAL DISPLAY DEVICE

(71) Applicants: Osamu Teranuma, Osaka-shi (JP); Makoto Shiomi, Osaka-shi (JP)

(72) Inventors: Osamu Teranuma, Osaka-shi (JP); Makoto Shiomi, Osaka-shi (JP)

(73) Assignee: SHARP KABUSHIKI KAISHA, Osaka-shi, Osaka (JP)

(21) Appl. No.: 14/117,923

(22) PCT Filed: May 17, 2012
(86) PCT No.: PCT/JP2012/062710

§ 371 Date: Nov. 15, 2013

(30) Foreign Application Priority Data
May 18, 2011 (JP) 2011-111902

(51) Int. Cl. G02F 1/133

(52) U.S. Cl. CPC G02F 1/13306
USPC 349/139

(57) ABSTRACT

A first and second region of a display device includes a plurality of scanning signal lines, a plurality of pixel electrodes, and a plurality of holding capacitance wires to which modulation signals are supplied. The plurality of scanning signal lines in the first and second regions are independently scanned. The display device includes a first trunk to which the plurality of holding capacitance wires that form capacitors along with the pixel electrodes in the first region are connected, but to which the holding capacitance wires that form capacitors along with the pixel electrodes in the second region are not connected; and a second trunk to which the plurality of holding capacitance wires that form the capacitors along with the pixel electrodes in the second region are connected, but to which the holding capacitance wires that form the capacitors along with the pixel electrodes in the first region are not connected.

### TECHNICAL FIELD

The present invention relates to a liquid crystal display device that performs multi-pixel driving.

### BACKGROUND ART

Multi-pixel driving has been put into practice in which two pixel electrodes are provided for each pixel that displays one primary color and a TFT (thin-film transistor) connected to one of the two pixel electrodes is connected to a data signal line and a scanning signal line while connecting a TFT (thin-film transistor) connected to another of the two pixel electrodes to the data signal line and the scanning signal line. By supplying modulation signals having different phases to a holding capacitance wire (CS wire) that forms a holding capacitor along with the one of the pixel electrodes and a holding capacitance wire (CS wire) that forms a holding capacitor along with the other of the pixel electrodes after writing the same potential to the two pixel electrodes from the data signal line, a bright region corresponding to the one of the pixel electrodes and a dark region corresponding to the other of the pixel electrodes are formed in each pixel at the time of displaying a halftone, thereby improving viewing angle characteristics (for example, refer to PTL 1).

In addition, so-called vertically divided driving has also been put into practice in which high-speed driving is realized by scanning a group of scanning signal lines formed in an upper half of a display unit and a group of scanning signal lines formed in a lower half of the display unit in parallel with each other. In PTL 2, a liquid crystal display device that combines the multi-pixel driving and the vertically divided driving is disclosed.

### CITATION LIST

### Patent Literature

PTL 1: Japanese Unexamined Patent Application Publication No. 2005-189804

PTL 2: Japanese Unexamined Patent Application Publication No. 2009-186616

### SUMMARY OF INVENTION

### Technical Problem

In the multi-pixel driving, as described in PTL 1, a trunk connected to a plurality of holding capacitance wires is provided, and modulation signals (CS signals) are supplied to the holding capacitance wires through the trunk.

It has been found out by the inventors, however, that when the multi-pixel driving and the vertically divided driving are combined as in PTL 2, display irregularities in the shape of horizontal stripes appear around a boundary between the upper half and the lower half of the display unit if the modulation signals are supplied to the holding capacitance wires in the upper half of the display unit and the holding capacitance wires in the lower half of the display unit through the same trunk.

An object of the present invention is to suppress failures in display around the boundary in the vertically divided driving.

### Solution to Problem

The present invention provides a liquid crystal display device whose display region is provided with first and second regions, the first region including a plurality of scanning signal lines, a plurality of pixel electrodes, and a plurality of holding capacitance wires to which modulation signals are supplied, the second region including a plurality of scanning signal lines, a plurality of pixel electrodes, and a plurality of holding capacitance wires to which modulation signals are supplied, the plurality of scanning signal lines in the first region and the plurality of scanning signal lines in the second region being independently scanned. The liquid crystal display device includes a first trunk to which the plurality of holding capacitance wires that form capacitors along with the pixel electrodes in the first region are connected but to which the holding capacitance wires that form capacitors along with the pixel electrodes in the second region are not connected, and a second trunk to which the plurality of holding capacitance wires that form the capacitors along with the pixel electrodes in the second region are connected but to which the holding capacitance wires that form the capacitors along with the pixel electrodes in the first region are not connected. According to this configuration, failures in display around a boundary may be suppressed in vertically divided driving.

### Advantageous Effects of Invention

According to the liquid crystal display device, failures in display around the boundary may be suppressed in the vertically divided driving.

### BRIEF DESCRIPTION OF DRAWINGS

FIG. 1 is a schematic diagram illustrating the configuration of a liquid crystal display device according to a first embodiment.

FIG. 2 is a circuit diagram illustrating a part of a liquid crystal panel illustrated in FIG. 1.

FIG. 3 is a circuit diagram illustrating another part of the liquid crystal panel illustrated in FIG. 1.

FIG. 4 is a timing chart illustrating a method (first embodiment) for driving the liquid crystal panel illustrated in FIGS. 2 and 3.

FIG. 5 is a circuit diagram illustrating the distribution (the part illustrated in FIG. 2) of pixel polarities at a time when the driving method illustrated in FIG. 4 is used.

FIG. 6 is a circuit diagram illustrating the distribution (the part illustrated in FIG. 3) of pixel polarities at a time when the driving method illustrated in FIG. 4 is used.

FIG. 7 is a circuit diagram illustrating the distribution (the part illustrated in FIG. 2) of bright and dark regions at a time when the driving method illustrated in FIG. 4 is used.

FIG. 8 is a circuit diagram illustrating the distribution (the part illustrated in FIG. 3) of bright and dark regions at a time when the driving method illustrated in FIG. 4 is used.

FIG. 9 is a timing chart illustrating another method (second embodiment) for driving the liquid crystal panel illustrated in FIGS. 2 and 3.

FIG. 10 is a schematic diagram illustrating the connection configuration of trunks, holding capacitance wires, and CS drivers according to the first embodiment.

FIG. 11 is a schematic diagram illustrating the connection configuration of two CS drivers, trunks, and holding capacitance wires according to a third embodiment.

FIG. 12 is a schematic diagram illustrating a modification of the third embodiment.

### DESCRIPTION OF EMBODIMENTS

### First Embodiment

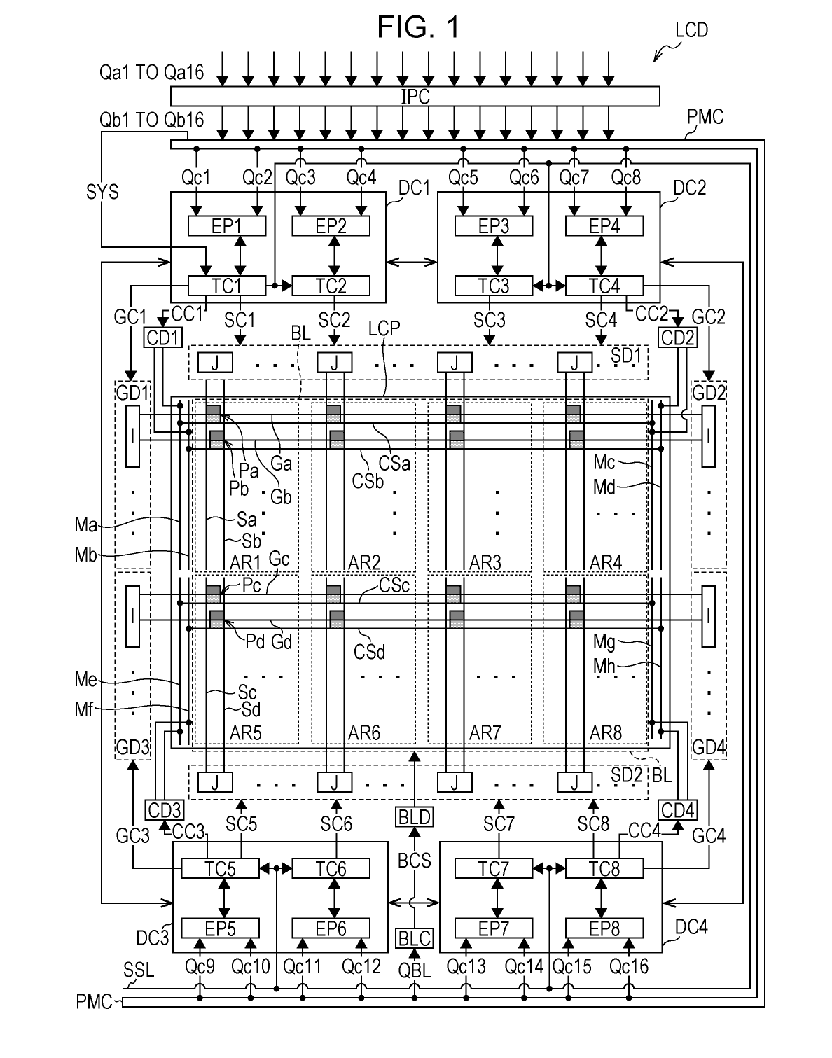

A liquid crystal display device LCD according to this embodiment complies with an image standard (for example, super high definition with a resolution of horizontal 7,680 pixels and vertical 4,320 pixels) having resolution (8K4K) sixteen times as high as full HD resolution, and, as illustrated in FIG. 1, includes an input processing circuit IPC, a pixel mapping circuit PMC, four display control boards (timing controller boards) DC1 to DC4, a liquid crystal panel LCP, four gate drivers GD1 to GD4, two source drivers SD1 to SDS2, four CS drivers CD1 to CD4, three power supply devices (not illustrated) connected to different commercial power supplies, a power supply controller (not illustrated), a backlight BL, a backlight driver BLD, and a backlight controller BLC.

An image signal input to the input processing circuit IPC may be an image signal of a block-scan format having 8K4K resolution (for example, super high definition), or may be an image signal of a multi-display format having 8K4K resolution. Needless to say, the image signal input to the input processing circuit IPC may be an image signal having 4K2K resolution or may be an image signal having 2K1K resolution (full HD resolution).

The block-scan format is a method for transmitting a frame (overall image having 8K4K resolution) while dividing the frame into sixteen low-resolution (full HD resolution) overall images (so-called thinned images). In this case, each of sixteen image signals Qa1 to Qa16 input to the input processing circuit IPC is a low-resolution (full HD resolution) overall image.

The multi-display format is a method for transmitting a frame (overall image having 8K4K resolution) while dividing the frame into sixteen partial images without changing the resolution. In this case, each of sixteen image signals Qa1 to Qa16 input to the input processing circuit IPC is a high-resolution (full HD resolution) partial image.

The input processing circuit IPC performs a process for synchronizing image data, a γ correction process, a process for correcting color temperature, a process for converting a gamut, and the like, and outputs image signals Qb1 to Qb16 to the pixel mapping circuit PMC.

Here, the display control board DC1 includes two image processing circuits EP1 and EP2 and two timing controllers TC1 and TC2. The display control board DC2 includes two image processing circuits EP3 and EP4 and two timing controllers TC3 and TC4. The display control board DC3 includes two image processing circuits EP5 and EP6 and two timing controllers TC5 and TC6. The display control board DC4 includes two image processing circuits EP7 and EP8 and two timing controllers TC7 and TC8.

The pixel mapping circuit PMC outputs an image signal (2K2K resolution) corresponding to a left half AR1 of a local area 1 (upper-left region when the liquid crystal panel LCP has been horizontally and vertically divided into four regions) to the image processing circuit EP1 of the display control board DC1 while dividing the image signal into two image signals (image signals Qc1 and Qc2 having full HD resolution), an image signal (2K2K resolution) corresponding to a right half AR2 of the local area 1 to the image processing circuit EP2 of the display control board DC1 while dividing the image signal into two image signals (image signals Qc3 and Qc4 having full HD resolution), an image signal (2K2K resolution) corresponding to a left half AR3 of a local area 2 (upper-right region when the liquid crystal panel LCP has been horizontally and vertically divided into four regions) to the image processing circuit EP3 of the display control board DC2 while dividing the image signal into two image signals (image signals Qc5 and Qc6 having full HD resolution), an image signal (2K2K resolution) corresponding to a right half AR4 of the local area 2 to the image processing circuit EP4 of the display control board DC2 while dividing the image signal into two image signals (image signals Qc7 and Qc8 having full HD resolution), an image signal (2K2K resolution) corresponding to a left half AR5 of a local area 3 (lower-left region when the liquid crystal panel LCP has been horizontally and vertically divided into four regions) to the image processing circuit EP5 of the display control board DC3 while dividing the image signal into two image signals (image signals Qc9 and Qc10 having full HD resolution), an image signal (2K2K resolution) corresponding to a right half AR6 of the local area 3 to the image processing circuit EP6 of the display control board DC3 while dividing the image signal into two image signals (image signals Qc11 and Qc12 having full HD resolution), an image signal (2K2K resolution) corresponding to a left half AR7 of a local area 4 (lower-right region when the liquid crystal panel LCP has been horizontally and vertically divided into four regions) to the image processing circuit EP7 of the display control board DC4 while dividing the image signal into two image signals (image signals Qc13 and Qc14 having full HD resolution), and an image signal (2K2K resolution) corresponding to a right half AR8 of the local area 4 to the image processing circuit EP8 of the display control board DC4 while dividing the image signal into two image signals (image signals Qc15 and Qc16 having full HD resolution).

Furthermore, the pixel mapping circuit PMC outputs a synchronization signal SYS (a vertical synchronization signal, a horizontal synchronization signal, a clock signal, a data enabling signal, a polarity inversion signal, or the like) to the timing controller TC1 of the display control board DC1, and upon receiving the synchronization signal SYS, the timing controller TC1 transmits the synchronization signal SYS to a board common line SSL connected to the display control boards DC1 to DC4.

After cooperating with the image processing circuit EP1 on the basis of the synchronization signal SYS received from the pixel mapping circuit PMC and performing image processing such as a process for converting the tones and a frame rate conversion (FRC) process on the image signals Qc1 and Qc2, the timing controller TC1 outputs a source control signal SC1 to a source driver board (not illustrated) corresponding to AR1, a gate control signal GC1 to a gate driver board (not illustrated) of the gate driver GD, and a CS control signal CC1 to the CS driver CD1.

After cooperating with the image processing circuit EP2 on the basis of the synchronization signal SYS transmitted from the timing controller TC1 through the board common line SSL and performing the image processing on the image signals Qc3 and Qc4, the timing controller TC2 outputs a source control signal SC2 to a source driver board (not illustrated) corresponding to AR2.

After cooperating with the image processing circuit EP3 on the basis of the synchronization signal SYS transmitted from the timing controller TC1 through the board common line SSL and performing the image processing on the image signals Qc5 and Qc6, the timing controller TC3 outputs a source control signal SC3 to a source driver board (not illustrated) corresponding to AR3.

After cooperating with the image processing circuit EP4 on the basis of the synchronization signal SYS transmitted from the timing controller TC1 through the board common line SSL and performing the image processing on the image signals Qc7 and Qc8, the timing controller TC4 outputs a source control signal SC4 to a source driver board (not illustrated) corresponding to AR4, a gate control signal GC2 to a gate driver board (not illustrated) of the gate driver GD2, and a CS control signal CC2 to the CS driver CD2.

After cooperating with the image processing circuit EP5 on the basis of the synchronization signal SYS transmitted from the timing controller TC1 through the board common line SSL and performing the image processing on the image signals Qc9 and Qc10, the timing controller TC5 outputs a source control signal SC5 to a source driver board (not illustrated) corresponding to AR5, a gate control signal GC3 to a gate driver board (not illustrated) of the gate driver GD3, and a CS control signal CC3 to the CS driver CD3.

After cooperating with the image processing circuit EP6 on the basis of the synchronization signal SYS transmitted from the timing controller TC1 through the board common line SSL and performing the image processing on the image signals Qc11 and Qc12, the timing controller TC6 outputs a source control signal SC6 to a source driver board (not illustrated) corresponding to AR6.

After cooperating with the image processing circuit EP7 on the basis of the synchronization signal SYS transmitted from the timing controller TC1 through the board common line SSL and performing the image processing on the image signals Qc13 and Qc14, the timing controller TC7 outputs a source control signal SC7 to a source driver board (not illustrated) corresponding to AR7.

After cooperating with the image processing circuit EP8 on the basis of the synchronization signal SYS transmitted from the timing controller TC1 through the board common line SSL and performing the image processing on the image signals Qc15 and Qc16, the timing controller TC8 outputs a source control signal SC8 to a source driver board (not illustrated) corresponding to AR8, a gate control signal GC4 to a gate driver board (not illustrated) of the gate driver GD4, and a CS control signal CC4 to the CS driver CD4.

The source control signals SC1 to SC8 include data signals, data enabling signals (DE signals), source start pulses, and source clocks, and the gate control signals GC1 to GC4 include initial signals, gate start pulses, and gate clocks.

Here, the process for converting the tones may include a high-speed display process (QS process) and a process for correcting the tones in accordance with the positions (positions in a column direction) of pixels for realizing a combination between panel vertically divided driving (described in detail later) and 1 V inversion driving (described in detail later).

In addition, in the FRC process, each image processing circuit may obtain a motion vector using one of the sixteen image signals Qa1 to Qa16 (low-resolution overall images having full HD resolution) and generate a partial image (full HD resolution) for interpolation using a corresponding one of the image signals Qc1 to Qc16 (high-resolution partial images having full HD resolution).

In addition, when an HDMI (High-Definition Multimedia Interface; registered trademark) that realizes 12-bit transfer is used for inputting the image signals Qc1 to Qc16, an error might be generated in which a DE signal (1,920 lines) extends forward by one clock (one line) and 1,921 lines might be obtained, and therefore the width of the DE signal may be monitored and, if 1,921 lines are obtained, a process for correcting an error in which the DE signal is delayed by one clock may be performed.

The display control boards DC1 to DC4 synchronize operations thereof with one another by communicating or sharing various signals therebetween. More specifically, the display control board DC1, which is a master, transmits an RDY (ready) signal to the display control board DC2, which is a slave, and the display control board DC2 that has received the RDY signal transmits the RDY signal to the display control board DC3, which is a slave, as soon as the display control board DC2 gets ready. The display control board DC3 that has received the RDY signal transmits the RDY signal to the display control board DC4, which is a slave, as soon as the display control board DC3 gets ready, and the display control board DC4 that has received the RDY signal sends the RDY signal back to the display control board DC1 as soon as the display control board DC4 gets ready. Upon receiving the RDY signal, the display control board DC1 transmits an operation start (SRST) signal to all the other display control boards DC2 to DC4 through the board common line SSL. After the operation start (SRST) signal is transmitted, the timing controller TC1 of the display control board DC1 transmits the synchronization signal SYS received from the pixel mapping circuit PMC to (the timing controllers TC2 to TC8 included in) all the display control boards DC1 to DC4 through the board common line SSL.

If an abnormality occurs in any of the display control boards DC1 to DC4 during operation, all the other display control boards receive a fail-safe signal transmitted from the display control board in which the abnormality has occurred, and all the display control boards DC1 to DC4 immediately enter a free-running (black display) mode. Therefore, abnormal display of an image may be avoided.

In addition, various driving power supplies are individually generated in each of the display control boards DC1 to DC4, and lines to which the same type (the same potential and the same phase) of driving power is supplied are connected to one another between the display control boards through current limiting circuits. In doing so, it is possible to prevent excessive current from flowing into various drivers and the display control boards due to differences in rising timing between the boards while adjusting the same types of driving power.

The liquid crystal panel LCP includes an active matrix substrate, a liquid crystal layer (not illustrated), and a counter substrate (not illustrated). In the active matrix substrate, a plurality of pixel electrodes (not illustrated), a plurality of TFTs (thin-film transistors; not illustrated), scanning signal lines Ga to Gd extending in a row direction (direction of the long sides of the panel), a plurality of data signal lines Sa to Sd extending in the column direction, holding capacitance wires (CS wires) CSa to CSd extending in the row direction, and CS trunks Ma to Mh extending in the column direction are provided. In the counter substrate, common electrodes (not illustrated), color filters, and a black matrix (not illustrated) are provided.

In addition, the gate driver GD1 is provided along one of the two short sides of an upper half of the liquid crystal panel LCP, and includes a plurality of gate driver chips I arranged in the column direction. The gate driver GD2 is provided along another of the two short sides of the upper half of the liquid crystal panel LCP, and includes a plurality of gate driver chips I arranged in the column direction. In addition, the gate driver GD3 is provided along one of the two short sides of a lower half of the liquid crystal panel LCP, and includes a plurality of gate driver chips I arranged in the column direction. The gate driver GD4 is provided along another of the two short sides of the lower half of the liquid crystal panel LCP, and includes a plurality of gate driver chips I arranged in the column direction. The scanning signal lines provided in the upper half of the panel are driven by the gate drivers GD1 and GD2, and the scanning signal lines provided in the lower half of the panel are driven by the gate drivers GD3 and GD4. That is, each scanning signal line is connected to two gate drivers arranged on both sides of each scanning signal line, and these two gate drivers supply scanning (pulse) signals having the same phase to each scanning signal line. Therefore, it is possible to suppress variation (changes in the degree of roundness of signal waveforms caused by the position in the row direction) in the roundness of signal waveforms caused by the CR (time constant) of each scanning signal line.

The source driver SD1 is provided along one of the long sides of the upper half of the liquid crystal panel LCP, and includes forty-eight source driver chips J (each source driver chip has nine hundred and sixty output terminals) arranged in the row direction and four source driver boards (each source driver board is mounted with twelve source driver chips J), which are not illustrated. On the other hand, the source driver SD2 is provided along one of the long sides of the lower half of the liquid crystal panel LCP, and includes forty-eight source driver chips J (each source driver chip includes nine hundred and sixty output terminals) arranged in the row direction and four source driver boards (each source driver board is mounted with twelve source driver chips J), which are not illustrated. The data signal lines provided in the upper half of the panel are driven by the source driver SD1, and the data signal lines provided in the lower half of the panel are driven by the source driver SD2. For example, the data signal line Sa is driven by the source driver SD1, and the data signal line Sc is driven by the source driver SD2. If the source driver chips J cannot be arranged along one of the long sides of the panel due to insufficient space, the source driver chips J may be arranged along one of the short sides of the panel (the source driver chips J and the gate driver chips I are arranged in the column direction), which might have sufficient space. In this case, a relay line that connects the data signal lines and source terminals at the short sides of the panel may be provided on the counter substrate or may be provided on a layer other than a source layer (layer on which source and drain electrodes of the TFTs are formed) of the active matrix substrate, that is, a layer (gate layer) under a gate insulating film or a layer between the source layer and an ITO layer (layer on which the pixel electrodes are formed).

The liquid crystal panel LCP has a so-called vertically divided double-source structure (structure in which four data signal lines are provided for each pixel column and in which four scanning signal lines may be simultaneously selected) in which two data signal lines are provided for an upper half (first region; upstream of the panel) of each pixel column and two data signal lines are provided for a lower half (second region; downstream of the panel) of each pixel column, and is capable of performing quadruple-speed driving. Furthermore, the liquid crystal panel LCP is of a so-called multi-pixel type in which at least two pixel electrodes are provided for each pixel, and is capable of improving viewing angle characteristics using a bright region and a dark region formed in each pixel.

For example, as illustrated in FIGS. 1 to 3, the scanning signal lines Ga and Gb and holding capacitance wires CSa and CSb are provided in the upper half (upstream) of the panel, and the scanning signal lines Gc and Gd and holding capacitance wires CSc and CSd are provided in the lower half (downstream) of the panel. Two pixels Pa and Pb adjacent to each other in the column direction are included in an upper half (upstream) of a pixel column PL1, and two pixels Pc and Pd adjacent to each other in the column direction are included in a lower half (downstream) of the pixel column PL1. Data signal lines Sa and Sb are provided for the upper half (upstream) of the pixel column PL1, and data signal lines Sc and Sd are provided for the lower half (downstream) of the pixel column PL1.

A TFT 12A connected to a pixel electrode 17A, which is one of two pixel electrodes 17A and 17a included in the pixel Pa, and a TFT 12a connected to the pixel electrode 17a are both connected to the data signal line Sa and the scanning signal line Ga. The pixel electrode 17A forms a holding capacitor CA along with a holding capacitance wire CSn, and the pixel electrode 17a forms a holding capacitor Ca along with the holding capacitance wire CSa. Furthermore, a TFT 12B connected to a pixel electrode 17B, which is one of two pixel electrodes 17B and 17b included in the pixel Pb, and a TFT 12b connected to the pixel electrode 17b are both connected to the data signal line Sb and the scanning signal line Gb. The pixel electrode 17B forms a holding capacitor CB along with the holding capacitance wire CSa, and the pixel electrode 17b forms a holding capacitor Cb along with the holding capacitance wire CSb. Furthermore, a TFT 12C connected to a pixel electrode 17C, which is one of two pixel electrodes 17C and 17c included in the pixel Pc, and a TFT 12c connected to the pixel electrode 17c are both connected to the data signal line Sc and the scanning signal line Gc. The pixel electrode 17C forms a holding capacitor CC along with a holding capacitance wire CSm, and the pixel electrode 17c forms a holding capacitor Cc along with the holding capacitance wire CSc. Furthermore, a TFT 12D connected to a pixel electrode 17D, which is one of two pixel electrodes 17D and 17d included in the pixel Pd, and a TFT 12d connected to the pixel electrode 17d are both connected to the data signal line Sd and the scanning signal line Gd. The pixel electrode 17D forms a holding capacitor CD along with the holding capacitance wire CSc, and the pixel electrode 17d forms a holding capacitor Cd along with the holding capacitance wire CSd. The four scanning signal lines Ga to Gd are simultaneously selected.

In the pixel column PL1, the data signal lines Sa and Sc are arranged in the column direction at a left end, and the data signal lines Sb and Sd are arranged in the column direction at a right end. In a pixel column PL2 adjacent to the pixel column PL1, data signal lines SA and SC are arranged in the column direction at a left end, and data signal lines SB and SD are arranged in the column direction at a right end.

In the pixel column PL2, two pixel electrodes included in a pixel adjacent to the pixel electrode Pa are connected to the data signal line SB through different TFTs, and two pixel electrodes included in a pixel adjacent to the pixel electrode Pb are connected to the data signal line SA through different TFTs. Two pixel electrodes included in a pixel adjacent to the pixel electrode Pc are connected to the data signal line SD through different TFTs, and two pixel electrodes included in a pixel adjacent to the pixel electrode Pd are connected to the data signal line SC through different TFTs.

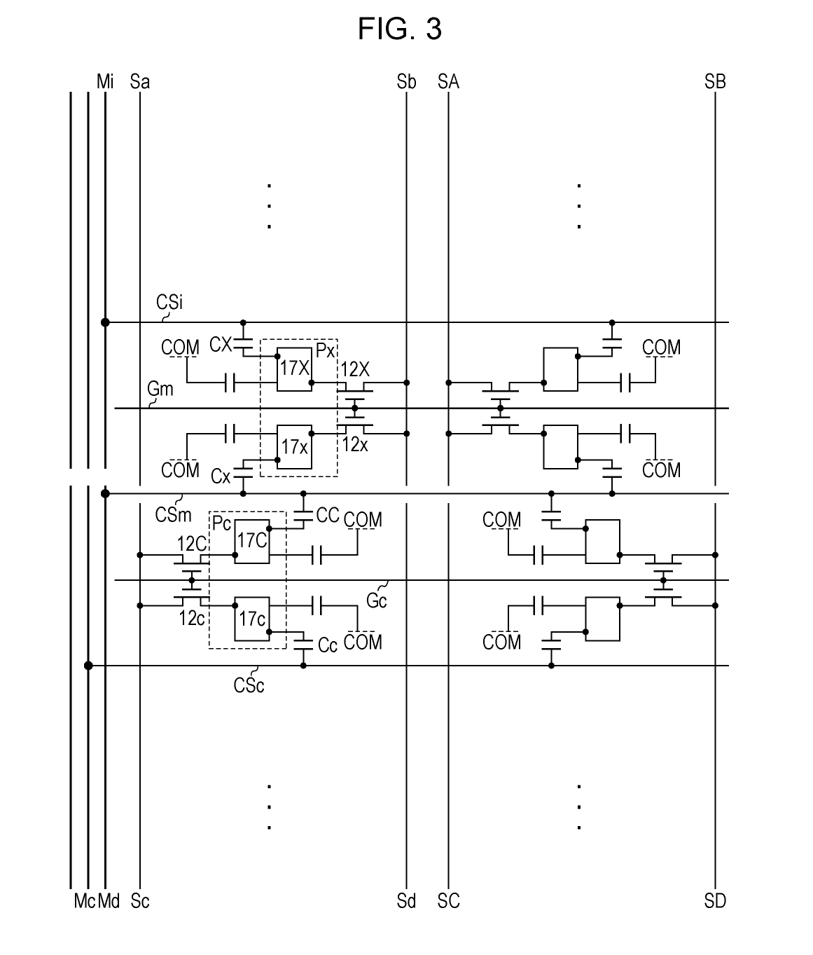

The configuration of a portion around a boundary between the upper half (first region) and the lower half (second region) is as illustrated in FIG. 3. That is, a TFT 12X connected to a pixel electrode 17X, which is one of two pixel electrodes 17X and 17x included in a pixel Px located at a bottom of the first region, and a TFT 12x connected to the pixel electrode 17x are both connected to the data signal line Sb and a scanning signal line Gm. The pixel electrode 17X forms a holding capacitor along with a holding capacitance wire CSi, and the pixel electrode 17x forms a holding capacitor along with the holding capacitance wire CSm. The pixel Pc is located at a top of the second region.

The number of data signal lines provided for the upper half of the panel is at least 7,680 (pixels)×3 (primary colors)×2 (double source)=46,080. The number of scanning signal lines provided for the upper half of the panel is at least 2,160. The number of holding capacitance wires provided for the upper half of the panel is at least 2,160. The number of data signal lines provided for the lower half of the panel is at least 46,080. The number of scanning signal lines provided for the lower half of the panel is at least 2,160. The number of holding capacitance wires provided for the lower half of the panel is at least 2,160.

The CS trunk Ma (first trunks) and the CS trunk Mb are provided close to one of the two short sides of the upper half of the active matrix substrate, and driven by the CS driver CD1 in such a way as to have different phases. The CS trunk Mc (third trunks) and the CS trunk Md are provided close to another of the two short sides of the upper half of the active matrix substrate, and driven by the CS driver CD2 in such a way as to have different phases. The CS trunk Me and the CS trunk Mf (second trunks) are provided close to one of the two short sides of the lower half of the active matrix substrate, and driven by the CS driver CD3 in such a way as to have different phases. The CS trunk Mg and the CS trunk Mh (fourth trunks) are provided close to another of the two short sides of the lower half of the active matrix substrate, and driven by the CS driver CD4 in such a way as to have different phases. Each holding capacitance wire is connected to two CS trunks provided on both sides of each holding capacitance wire, and these two CS trunks supply modulation (pulse) signals having the same phase to each holding capacitance wire. Therefore, it is possible to suppress variation (changes in the degree of roundness of signal waveforms caused by the position in the row direction) in the roundness of signal waveforms caused by the CR (time constant) of each holding capacitance wire.

For example, the holding capacitance wire CSa is connected to the CS trunks Ma and Mc, the holding capacitance wire CSb is connected to the CS trunks Mb and Md, the holding capacitance wire CSc is connected to the CS trunks Me and Mg, and the holding capacitance wire CSd is connected to the CS trunks Mf and Mh. Therefore, for example, by performing control such that the potential of the CS trunks Ma and Mb has opposite phases, the potential of the holding capacitance wires CSa and CSb also has opposite phases. Since, in the pixel Pb, the pixel electrode 17B, which is one of the two pixel electrodes 17B and 17b, forms a capacitor along with the holding capacitance wire CSa and the pixel electrode 17b forms a capacitor along with the holding capacitance wire CSb, for example, the effective potential of the pixel electrode 17B may be shifted toward a central potential while shifting the effective potential of the pixel electrode 17b away from the central potential (therefore, a dark region corresponding to the pixel electrode 17B and a bright region corresponding to the pixel electrode 17b are formed in one pixel) after writing the same signal potential to the pixel electrodes 17B and 17b.

The polarity of a data signal supplied to each data signal line is inverted in every vertical scanning period (1 V), and in the same vertical scanning period, the polarities of data signals supplied to one and another of two data signal lines provided for each pixel column are opposite. Therefore, the polarity distribution of pixels in a screen may be controlled using a dot inversion method (accordingly, flickering caused by pull-in voltage generated when a TFT is turned off may be suppressed) while inverting each data signal line at 1 V (that is, power consumption is reduced by increasing a polarity inversion period).

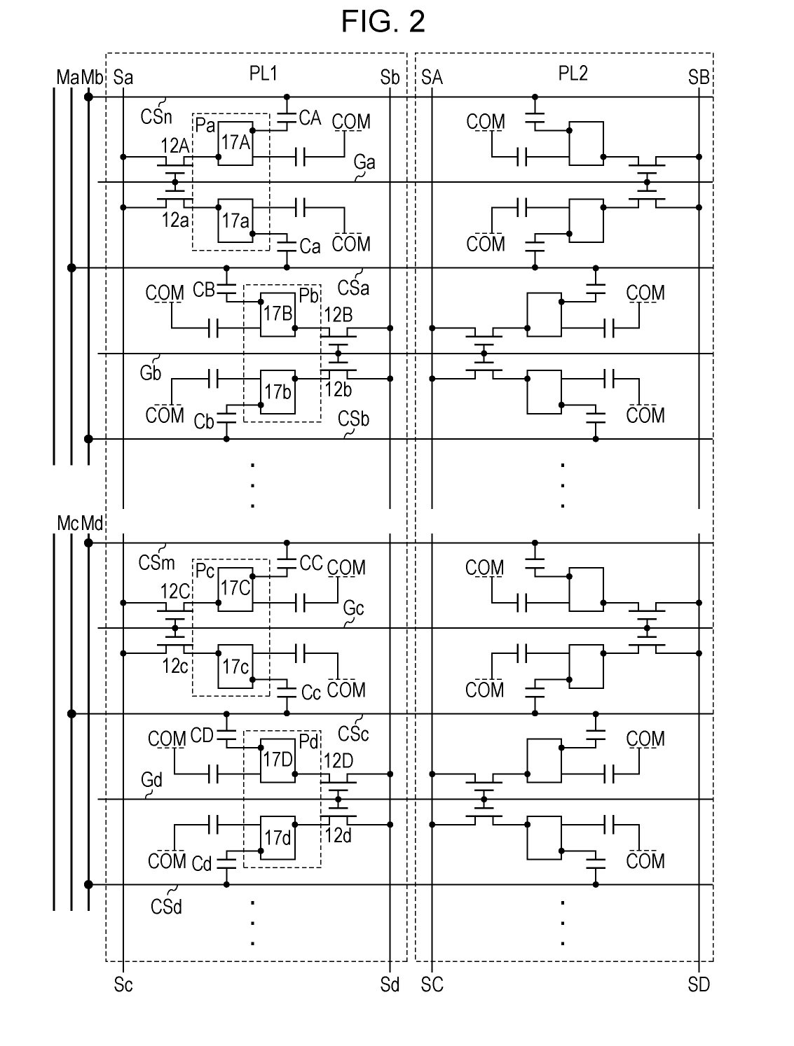

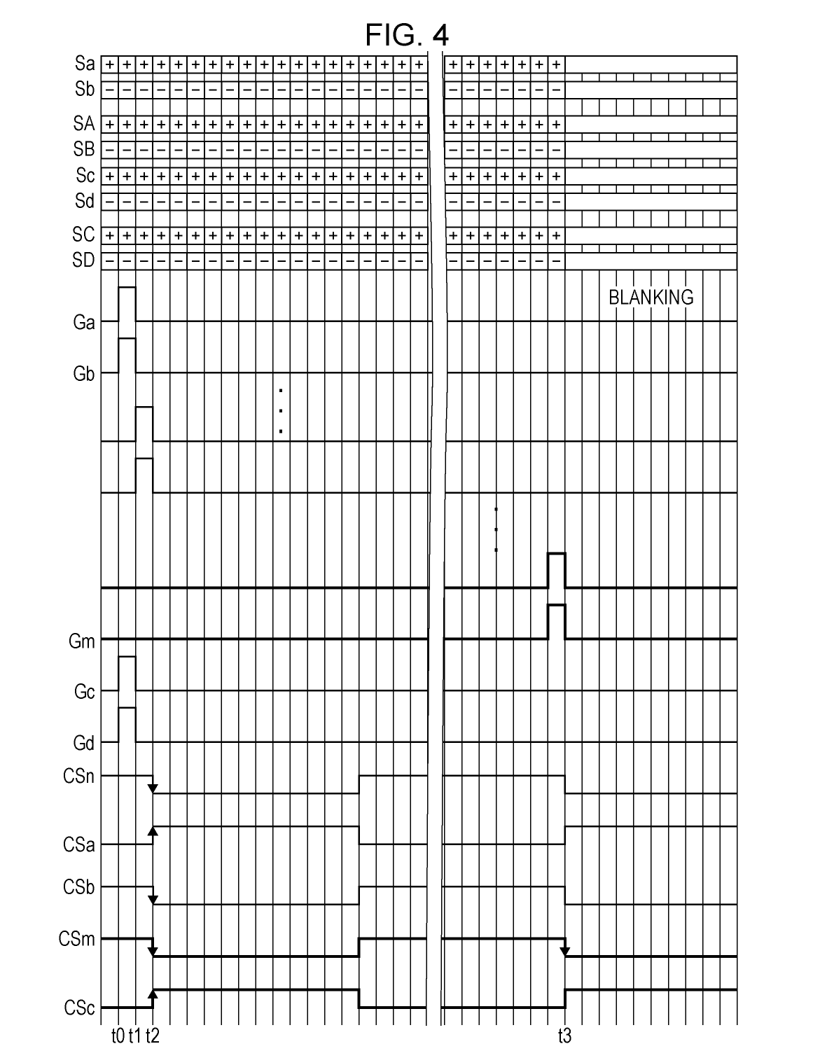

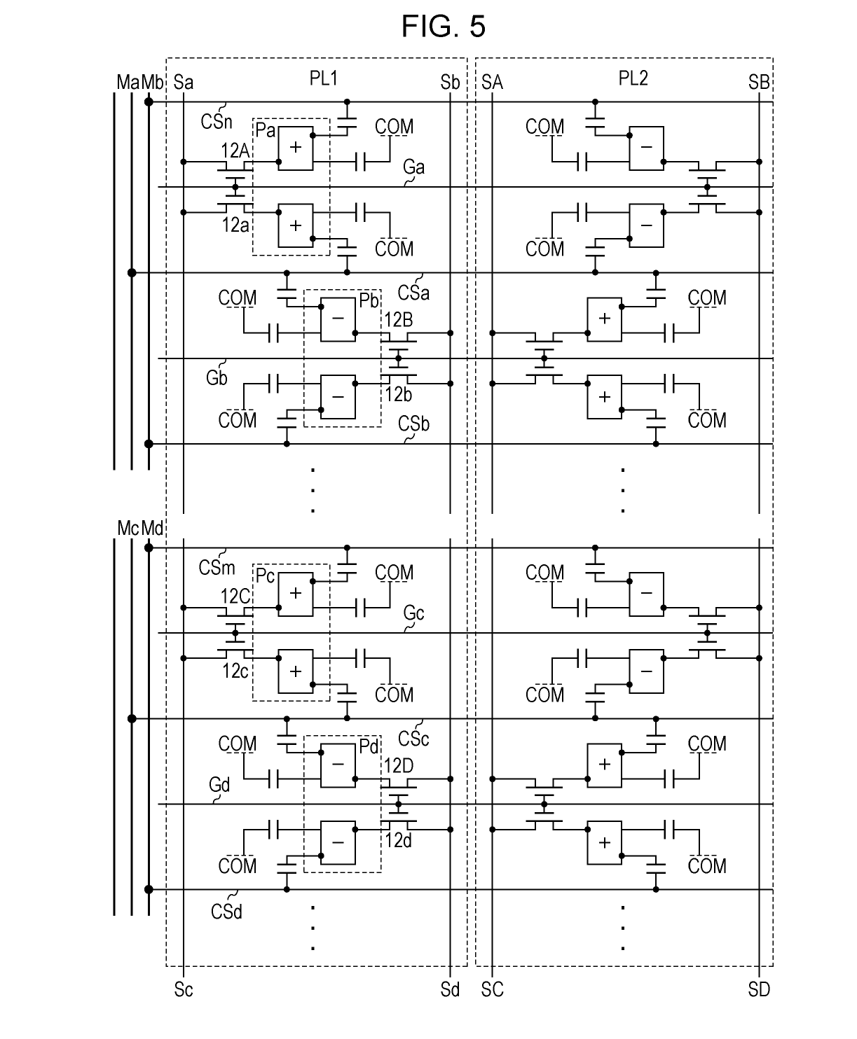

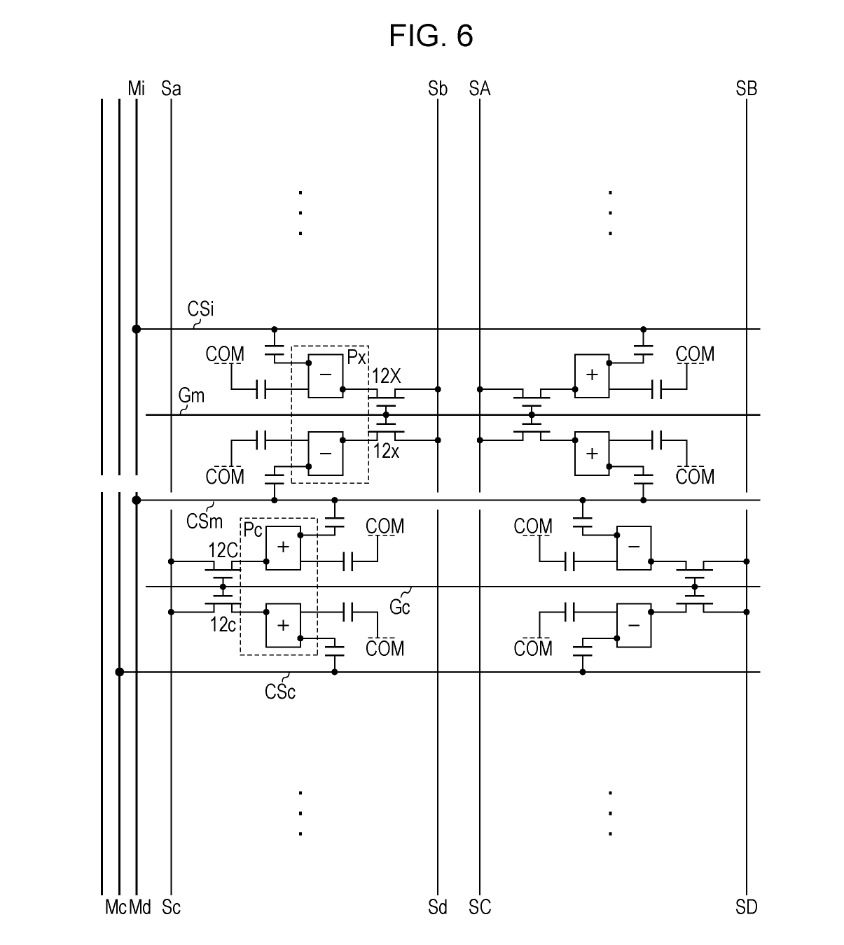

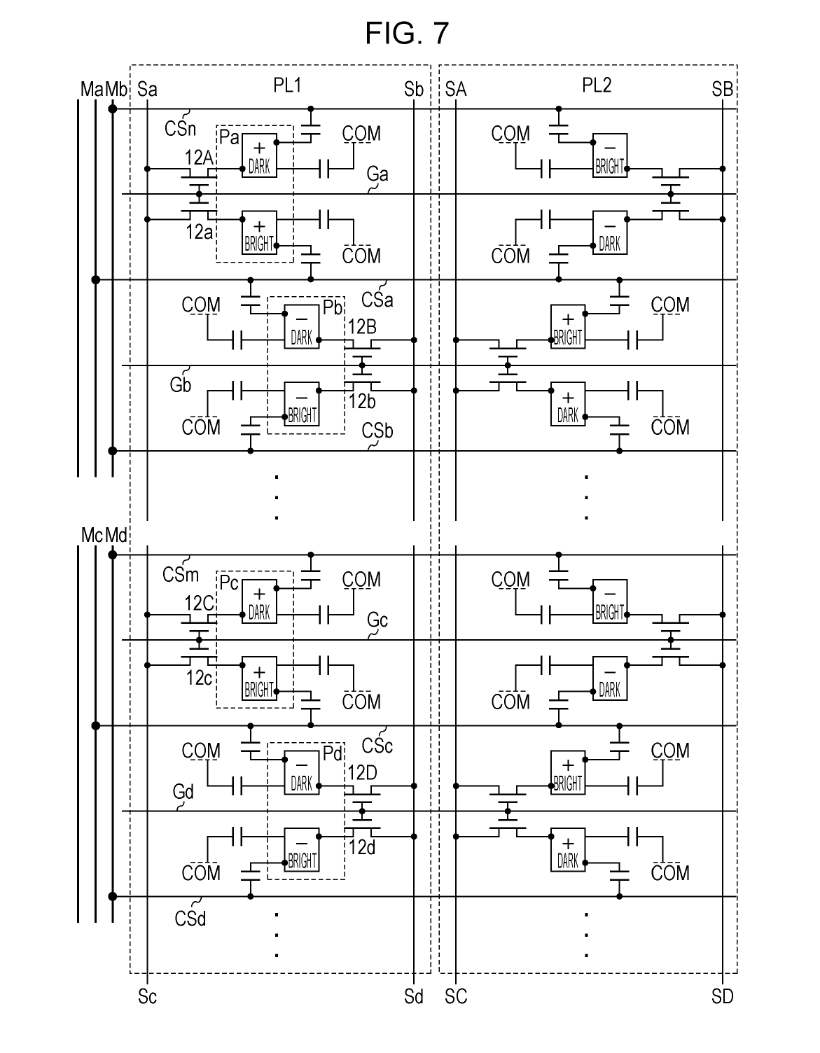

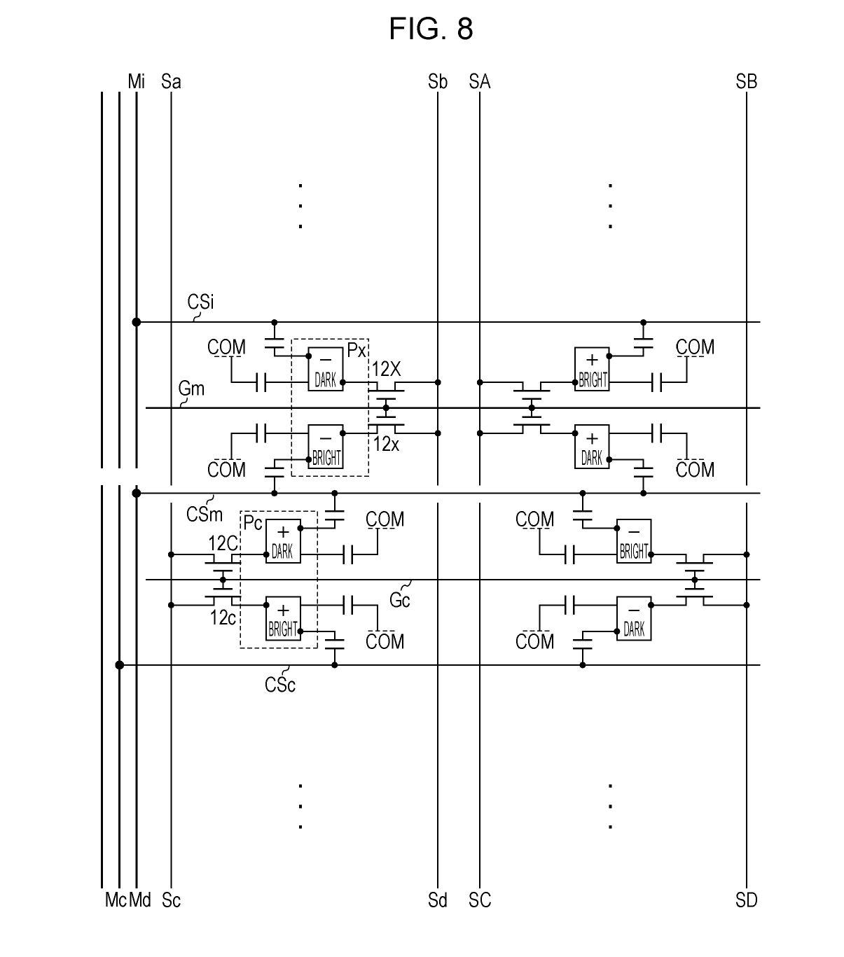

A method for driving the portions of the liquid crystal panel illustrated in FIGS. 2 and 3 is illustrated in a timing chart of FIG. 4 and schematic diagrams of FIGS. 5 to 8. As illustrated in FIG. 4, a positive data signal potential is supplied to the data signal lines Sa, SA, Sc, and SC in a vertical scanning period, and a negative data signal potential is supplied to the data signal lines Sb, SB, Sd, and SD in the vertical scanning period.

At a time t0, the scanning signal lines Ga and Gb are simultaneously scanned, and at a time t1, which is 1H (vertical scanning period) after t0, the simultaneous scanning of the scanning signal lines Ga to Gd ends. As a result, a positive data signal potential is written to the pixel electrodes 17A and 17a, a positive data signal potential is written to the pixel electrodes 17C and 17c, a negative data signal potential is written to the pixel electrodes 17B and 17b, and a negative data signal potential is written to the pixel electrodes 17D and 17d.

At t2, which is 1H after t1, the potential of the holding capacitance wire CSn is shifted to L (low) by a modulation signal transmitted from the CS trunk Mb, and accordingly the potential of the pixel electrode 17A drops and the effective potential until next scanning becomes lower than the written data signal potential (+) (a dark region is established). In addition, at t2, the potential of the holding capacitance wire CSa is shifted to H (high) by modulation signals transmitted from the CS drivers CD1 and CD2 through the CS trunks Ma and Mc, and accordingly the potential of the pixel electrode 17a rises and the effective potential until the next scanning becomes higher than the written data signal potential (+) (a bright region is established). In addition, at t2, the potential of the pixel electrode 17B rises (because the potential of the holding capacitance wire CSa is shifted to H), and accordingly the effective potential until the next scanning becomes higher than the written data signal potential (−) (a dark region is established).

Furthermore, at t2, the potential of the holding capacitance wire CSm is shifted to L (low) by a modulation signal transmitted from the CS trunk Md, and accordingly the potential of the pixel electrode 17C drops and the effective potential until the next scanning becomes lower than the written data signal potential (+) (a dark region is established). In addition, at t2, the potential of the holding capacitance wire CSc is shifted to H (high) by modulation signals transmitted from the CS drivers CD3 and CD4 through the CS trunks Me and Mg, and accordingly the potential of the pixel electrode 17c rises and the effective potential until the next scanning becomes higher than the written data signal potential (+) (a bright region is established).

Furthermore, at t2, the potential of the holding capacitance wire CSb is shifted to L by modulation signals transmitted from the CS drivers CD1 and CD2 through the CS trunks Mb and Md, and accordingly the potential of the pixel electrode 17b drops and the effective potential until the next scanning becomes lower than the written data signal potential (−) (a bright region is established).

When scanning of the pixel Px located at the bottom of the first region has ended at a time t3, a negative data signal potential is written to the pixel electrodes 17X and 17x. Furthermore, at t3, the potential of the holding capacitance wire CSm is shifted to L (low) by a modulation signal transmitted from the CS trunk Md, and accordingly the potential of the pixel electrode 17x drops and the effective potential until the next scanning becomes lower than the written data signal potential (−) (a bright region is established).

As described above, since the polarity of a data signal supplied to each data signal line is inverted in every vertical scanning period (1 V), the phase of each CS modulation signal is also inverted in every vertical scanning period (1 V). As a result, the bright region and the dark region of each pixel are continuously maintained.

As described above, since the CS trunks are divided into those for the upper half (first region) and those for the lower half (second region), the holding capacitance wire CSm belonging to the second region at a position close to the boundary between the upper half (first region) and the lower half (second region) may be subjected to modulation driving without being affected by the modulation timing of CS signals in the first region.

Thus, by dividing the CS trunks into those for the first region and those for the second region and separately driving these trunks, display around the boundary between the first region and the second region may be adjusted (corrected).

With respect to the simultaneously selected four scanning signal lines Ga to Gd, if the scanning signal line Ga is located in an n-th line from the upper long side of the panel and the scanning signal line Gb is located in an (n+1)th line (in FIGS. 2 to 9, n=0), the scanning signal line Gc is located in an (n+2,160)th line from the upper long side and the scanning signal line Gd is located in an (n+2,161)th line. If a data signal of the n-th line in an N-th frame is written to the scanning signal line Ga, which is provided for the upper half of the panel, a data signal of the (n+2,160)th line in an (N−1)th frame, which is a frame prior to the N-th frame, is written to the scanning signal line Gc, which is provided for the lower half of the panel. As a result, deviation in display between the upper half and the lower half of the panel may be suppressed.

In the liquid crystal display device LCD illustrated in FIG. 1, for example, a path length Ka from the CS trunk Ma to the CS trunk Mc through the holding capacitance wire CSa, a path length Kb from the CS trunk Mb to the CS trunk Md through the holding capacitance wire CSb, a path length Kc from the CS trunk Me to the CS trunk Mg through the holding capacitance wire CSc, and a path length Kd from the CS trunk Mf to the CS trunk Mh through the holding capacitance wire CSd are the same.

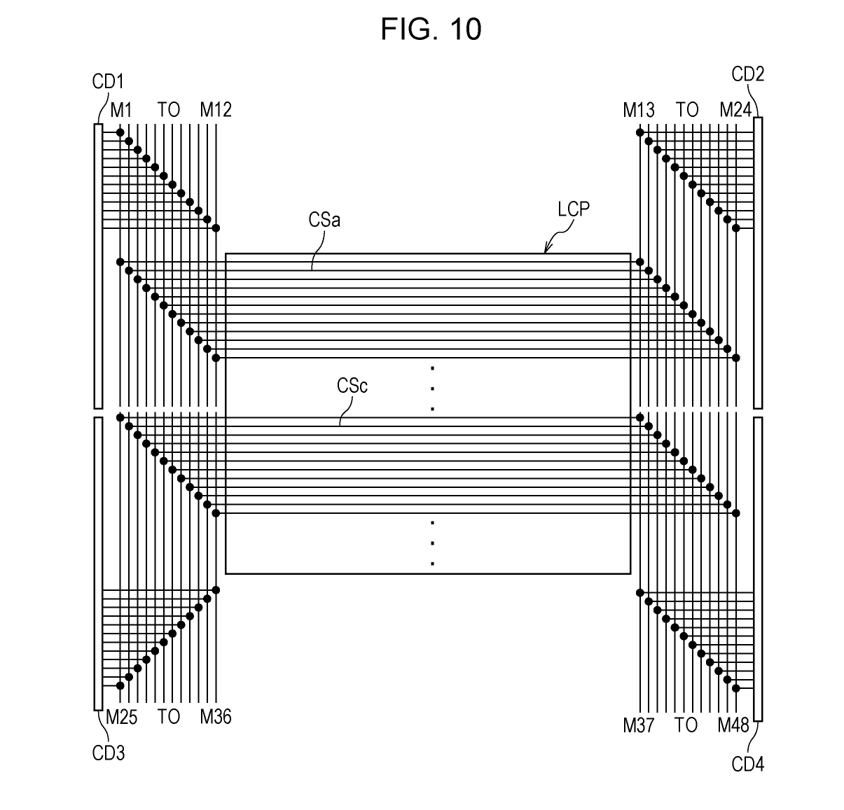

Furthermore, the sum of the length of a connecting line between the CS driver CD1 and the CS trunk Ma, Ka, and the length of a connecting line between the CS trunk Mc and the CS driver CD2, the sum of the length of a connecting line between the CS driver CD1 and the CS trunk Mb, Kb, and the length of a connecting line between the CS trunk Md and the CS driver CD2, the sum of the length of a connecting line between the CS driver CD3 and the CS trunk Me, Kc, and the length of a connecting line between the CS trunk Mg and the CS driver CD4, and the sum of the length of a connecting line between the CS driver CD3 and the CS trunk Mf, Kd, and the length of a connecting line between the CS trunk Mh and the CS driver CD4 are the same (refer to FIG. 10; Ma and Mb are included in M1 to M12, Mc and Md are included in M13 to M24, Me and Mf are included in M25 to M36, and Mg and Mh are included in M37 to M48).

By adopting the above-described configuration, display irregularities caused by parasitic resistance (wire resistance) and variation in the parasitic capacitance between paths may be suppressed.

Upon receiving an image signal QBL output from the pixel mapping circuit PMC, the backlight controller BLC outputs a backlight control signal to the backlight driver BD, and the backlight BL is driven by the backlight driver BD. The backlight BL is divided into a plurality of regions, and the luminance of each region is independently adjusted in accordance with the image signal QBL (active backlight).

The power supply controller monitors the supplied power level of the commercial power supplies connected to three power supply circuits, and if an abnormality (decrease in the supplied power level) occurs in one or a plurality of commercial power supplies for some reason, power supply lines (for example, three lines for R, B, and G) to the backlight BL and a power supply line (for example, one line) to the display control boards DC1 to DC4 are replaced by one or a plurality of normal commercial power supplies, and an abnormality occurrence signal is output to the backlight controller BLC. Upon receiving the abnormality occurrence signal, the backlight controller BLC outputs a control signal for decreasing an upper limit of the luminance of the backlight BL to the backlight driver BD. As a result, it is possible to avoid damage to the display control boards DC1 to DC4 or the like due to an unexpected abnormality in the commercial power supplies.

When the three power supply circuits are no longer necessary due to power saving of the liquid crystal display device or the like and a configuration in which only one power supply circuit connected to a commercial power supply is provided has become possible, the power supply controller may monitor the supplied power level of this commercial power supply, and if an abnormality (decrease in the supplied power level) occurs in the commercial power supply for some reason, output an abnormality occurrence signal to the backlight controller BLC (upon receiving the abnormality occurrence signal, the backlight controller BLC outputs a control signal for decreasing the upper limit of the luminance of the backlight BL to the backlight driver BD).

### Second Embodiment

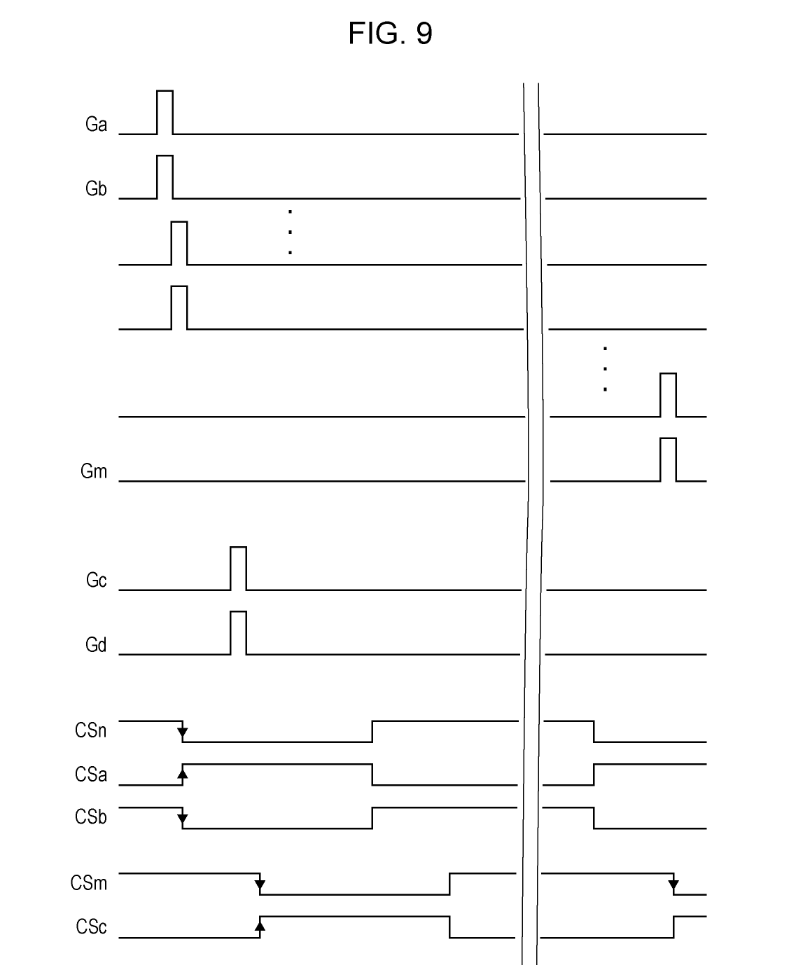

Although the scanning signal lines Ga and Gb located at a top (first and second lines) of the first region and the scanning signal lines Gc and Gd located at the top (first and second lines) of the second region are simultaneously scanned in FIG. 4, the present invention is not limited to this. As illustrated in FIG. 9, the scanning signal lines Gc and Gd located at the top (first and second lines) of the second region may be scanned a certain period of time later than the scanning signal lines Ga and Gb located at the top of the first region. At this time, if each CS signal is modulated in accordance with vertical (gate) scanning, each CS modulation signal in the second region is driven the certain period of time later than each CS modulation signal in the first region. Thus, by delaying the beginning of scanning in the second region by nH (n is a natural number) compared to the beginning of scanning in the first region, it is possible to adjust CS modulation signals around the boundary between the first region and the second region and adjust (correct) display.

Although the scanning signal lines Gc and Gd located at the top (first and second lines) of the second region are driven a certain period of time later than the scanning signal lines Ga and Gb located at the top of the first region in the above description, the scanning signal lines Gc and Gd may be operated a certain period of time earlier, instead. In this case, the CS modulation signals in the second region are driven the certain period of time earlier than the CS modulation signals in the first region, and, as in the above case, it is possible to adjust display around the boundary.

### Third Embodiment

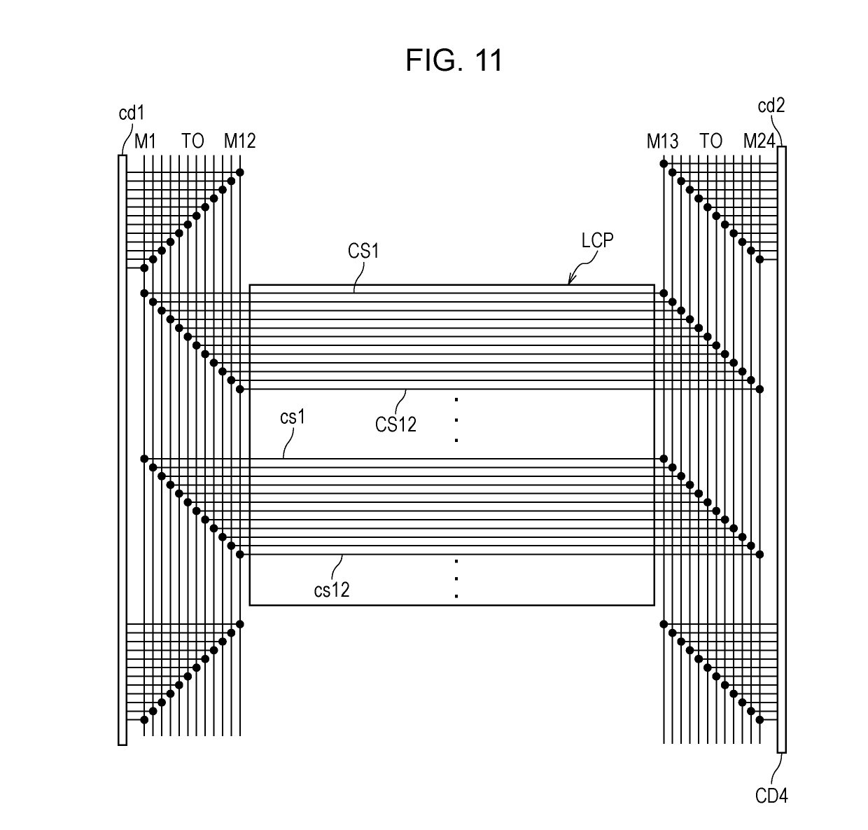

In addition, as illustrated in FIG. 11, holding capacitance wires CS1 to CS12 may be provided in the first region of a display unit, and holding capacitance wires cs1 to cs12 may be provided in the second region of the display unit (the first region and the second region are independently driven). CS trunks M1 to M12 and a CS driver cd1 may be provided on one side of the display unit, and CS trunks M13 to M24 (supplied with modulation signals having the same phase as those for the CS trunks M1 to M12) and a CS driver cd2 may be provided on another side of the display unit. The sum of the length of a connecting line between the CS driver cd1 and the CS trunk M1, a path length K1 from the CS trunk M1 to the CS trunk M13 through the holding capacitance wire CS1, and the length of a connecting line between the CS trunk M13 and the CS driver cd2, the sum of a connecting line between the CS driver cd1 and the CS trunk M12, a path length K2 from the CS trunk M12 to the CS trunk M24 through the holding capacitance wire CS12, and the length of a connecting line between the CS trunk M24 and the CS driver cd2, the sum of the connecting line between the CS driver cd1 and the CS trunk M1, a path length K3 from the CS trunk M1 to the CS trunk M13 through the holding capacitance wire cs1, and the length of a connecting line between the CS trunk M13 and the CS driver cd2, and the sum of the connecting line between the CS driver cd1 and the CS trunk M12, a path length K4 from the CS trunk M12 to the CS trunk M24 through the holding capacitance wire cs12, and the length of the connecting line between the CS trunk M24 and the CS driver cd2 may be the same.

By adopting the configuration illustrated in FIG. 11, display irregularities caused by parasitic resistance (wire resistance) and variation in the parasitic capacitance between paths may be suppressed.

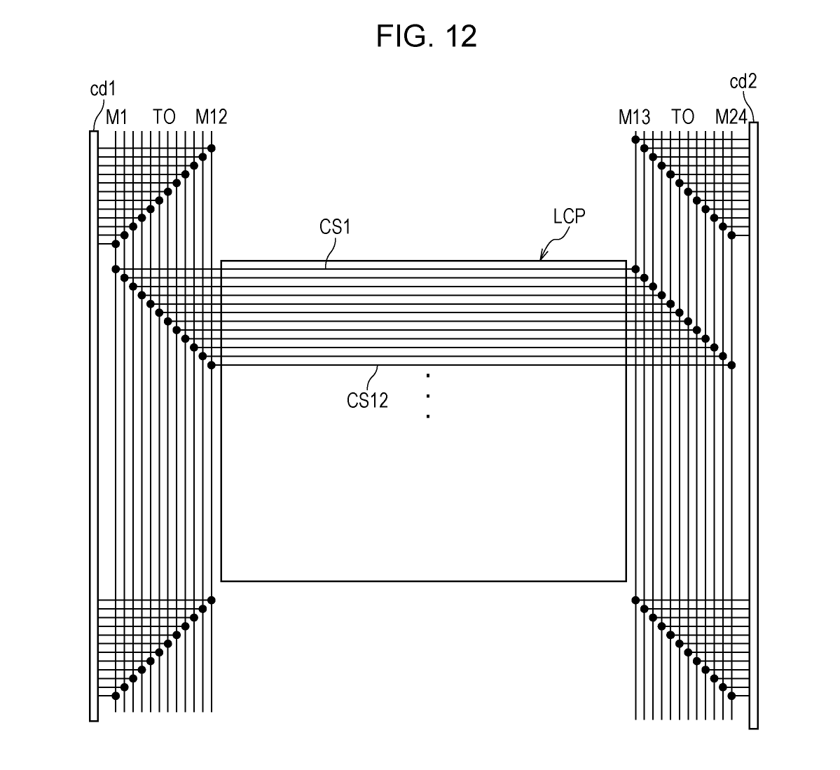

In addition, as illustrated in FIG. 12, the holding capacitance wires CS1 to CS12 may be provided in the display unit (whole surface single driving), the CS trunks M1 to M12 and the CS driver cd1 may be provided on one side of the display unit, and the CS trunks M13 to M24 (supplied with modulation signals having the same phase as those for the CS trunks M1 to M12) and the CS driver cd2 may be provided on another side of the display unit. The sum of the length of the connecting line between the CS driver cd1 and the CS trunk Ml, the path length K1 from the CS trunk M1 to the CS trunk M13 through the holding capacitance wire CS1, and the length of the connecting line between the CS trunk M13 and the CS driver cd2 and the sum of the connecting line between the CS driver cd1 and the CS trunk M12, the path length K2 from the CS trunk M12 to the CS trunk M24 through the holding capacitance wire CS12, and the length of the connecting line between the CS trunk M24 and the CS driver cd2 may be the same.

By adopting the configuration illustrated in FIG. 12, display irregularities caused by parasitic resistance (wire resistance) and variation in the parasitic capacitance between paths may be suppressed.

As described above, the present invention provides a liquid crystal display device whose display region is provided with first and second regions, the first region including a plurality of scanning signal lines, a plurality of pixel electrodes, and a plurality of holding capacitance wires to which modulation signals are supplied, the second region including a plurality of scanning signal lines, a plurality of pixel electrodes, and a plurality of holding capacitance wires to which modulation signals are supplied, the plurality of scanning signal lines in the first region and the plurality of scanning signal lines in the second region being independently scanned. The liquid crystal display device includes a first trunk to which the plurality of holding capacitance wires that form capacitors along with the pixel electrodes in the first region are connected but to which the holding capacitance wires that form capacitors along with the pixel electrodes in the second region are not connected, and a second trunk to which the plurality of holding capacitance wires that form the capacitors along with the pixel electrodes in the second region are connected but to which the holding capacitance wires that form the capacitors along with the pixel electrodes in the first region are not connected.

According to this configuration, failures in display around the boundary may be suppressed in vertically divided driving.

In the liquid crystal display device, scanning directions of the first and second regions may be the same, and the first and second regions may be arranged in the scanning directions.

In the liquid crystal display device, each pixel in the first region may include two pixel electrodes, each of which forms a capacitor along with a different holding capacitance wire. Each pixel in the second region may include two pixel electrodes, each of which forms a capacitor along with a different holding capacitance wire.

In the liquid crystal display device, in the first region, a pixel electrode included in one of two pixels adjacent to each other in a scanning direction and a pixel electrode included in another of the two pixels adjacent to each other in the scanning direction may form capacitors along with the same holding capacitance wire. In the second region, a pixel electrode included in one of two pixels adjacent to each other in a scanning direction and a pixel electrode included in another of the two pixels adjacent to each other in the scanning direction may form capacitors along with the same holding capacitance wire.

The liquid crystal display device may further include a first driver circuit that supplies modulation signals to the first trunk, and a second driver circuit that supplies modulation signals to the second trunk. The first and second driver circuits may be formed on different display control boards.

The liquid crystal display device may further include a third trunk to which modulation signals having the same phase as those supplied to the first trunk are supplied, and a fourth trunk to which modulation signals having the same phase as those supplied to the second trunk are supplied. Another end of each holding capacitance wire whose one end is connected to the first trunk may be connected to the third trunk. Another end of each holding capacitance wire whose one end is connected to the second trunk may be connected to the fourth trunk.

In the liquid crystal display device, a first path length from the first trunk to the third trunk through each holding capacitance wire and a second path length from the second trunk to the fourth trunk through each holding capacitance wire may be the same.

The liquid crystal display device may further include a first driver circuit that supplies modulation signals to the first trunk, a second driver circuit that supplies modulation signals to the second trunk, a third driver circuit that supplies modulation signals to the third trunk, and a fourth driver circuit that supplies modulation signals to the fourth trunk. The sum of a length of a connecting line between the first driver circuit and the first trunk, the first path length, and a length of a connecting line between the third driver circuit and the third trunk and the sum of a length of a connecting line between the second driver circuit and the second trunk, the second path length, and a length of a connecting line between the fourth driver circuit and the fourth trunk may be the same.

In the liquid crystal display device, a scanning signal line in a first line of the first region may be scanned one or a plurality of horizontal scanning periods before or after a scanning signal line in a first line of the second region.

In the liquid crystal display device, in the first region, a pixel electrode included in one of two pixels adjacent to each other in a scanning direction may be connected to a first data signal line through a first transistor and a pixel electrode included in another of the two pixels adjacent to each other in the scanning direction may be connected to a second data signal line through a second transistor. In the second region, a pixel electrode included in one of two pixels adjacent to each other in a scanning direction may be connected to a third data signal line through a third transistor and a pixel electrode included in another of the two pixels adjacent to each other in the scanning direction may be connected to a fourth data signal line through a fourth transistor.

The liquid crystal display device may further include a fifth trunk to which holding capacitance wires that form capacitors along with the pixel electrodes in the first region and that forms capacitors along with the pixel electrodes in the second region are connected.

In the liquid crystal display device, two scanning signal lines in the first region and two scanning signal lines in the second region may be simultaneously scanned.

The present invention is not limited to the above embodiments, and modifications of the above embodiments and combinations between the above embodiments based on common knowledge in the art are also included in the embodiments of the present invention.

### INDUSTRIAL APPLICABILITY

The present invention may be preferably applied to, for example, a liquid crystal display device.

### REFERENCE SIGNS LIST

LCD liquid crystal display device
LCP liquid crystal panel
CD1 to CD4 CD driver
CSa to CSd holding capacitance wire
CSn and CSm holding capacitance wire
Ma to Mh CS trunk (trunk)
M1 to M48 CS trunk (trunk)
Pa to Pd pixel
Ga to Gd scanning signal line
17a and 17A pixel electrode
17b and 17B pixel electrode
12a and 12A transistor
12b and 12B transistor
Sa to Sd data signal line
SA to SD data signal line
AR1 to AR4 (local areas 1 and 2) first region
AR5 to AR8 (local areas 3 and 4) second region

1. A liquid crystal display device whose display region is provided with first and second regions, the first region including a plurality of scanning signal lines, a plurality of pixel electrodes, and a plurality of holding capacitance wires to which modulation signals are supplied, the second region including a plurality of scanning signal lines; a plurality of pixel electrodes, and a plurality of holding capacitance wires to which modulation signals are supplied, the plurality of scanning signal lines in the first region and the plurality of scanning signal lines in the second region being independently scanned, the liquid crystal display device comprising:
a first trunk to which the plurality of holding capacitance wires that form capacitors along with the pixel electrodes in the first region are connected but to which the holding capacitance wires that form capacitors along with the pixel electrodes in the second region are not connected; and
a second trunk to which the plurality of holding capacitance wires that form the capacitors along with the pixel electrodes in the second region are connected but to which the holding capacitance wires that form the capacitors along with the pixel electrodes in the first region are not connected;
wherein, in the first region, a pixel electrode included in one of two pixels adjacent to each other in a scanning direction is connected to a first data signal line through a first transistor and a pixel electrode included in another of the two pixels adjacent to each other in the scanning direction is connected to a second data signal line through a second transistor, and
wherein, in the second region, a pixel electrode included in one of two pixels adjacent to each other in a scanning direction is connected to a third data signal line through a third transistor and a pixel electrode included in another of the two pixels adjacent to each other in the scanning direction is connected to a fourth data signal line through a fourth transistor.

2. The liquid crystal display device according to claim 1,
wherein scanning directions of the first and second regions are the same, and the first and second regions are arranged in the scanning directions.

3. The liquid crystal display device according to claim 1,
wherein each pixel in the first region includes two pixel electrodes, each of which forms a capacitor along with a different holding capacitance wire, and
wherein each pixel in the second region includes two pixel electrodes, each of which forms a capacitor along with a different holding capacitance wire.

4. The liquid crystal display device according to claim 3,
wherein, in the first region, a pixel electrode included in one of two pixels adjacent to each other in a scanning direction and a pixel electrode included in another of the two pixels adjacent to each other in the scanning direction form capacitors along with the same holding capacitance wire, and
wherein, in the second region, a pixel electrode included in one of two pixels adjacent to each other in a scanning direction and a pixel electrode included in another of the two pixels adjacent to each other in the scanning direction form capacitors along with the same holding capacitance wire.

5. The liquid crystal display device according to claim 1, further comprising:
a first driver circuit that supplies modulation signals to the first trunk; and
a second driver circuit that supplies modulation signals to the second trunk,
wherein the first and second driver circuits are formed on different display control boards.

6. The liquid crystal display device according to claim 1, further comprising:
a third trunk to which modulation signals having the same phase as those supplied to the first trunk are supplied; and
a fourth trunk to which modulation signals having the same phase as those supplied to the second trunk are supplied,
wherein another end of each holding capacitance wire whose one end is connected to the first trunk is connected to the third trunk, and
wherein another end of each holding capacitance wire whose one end is connected to the second trunk is connected to the fourth trunk.

7. The liquid crystal display device according to claim 6,
wherein a first path length from the first trunk to the third trunk through each holding capacitance wire and a second path length from the second trunk to the fourth trunk through each holding capacitance wire are the same.

8. The liquid crystal display device according to claim 7, further comprising:
a first driver circuit that supplies modulation signals to the first trunk;
a second driver circuit that supplies modulation signals to the second trunk;
a third driver circuit that supplies modulation signals to the third trunk; and
a fourth driver circuit that supplies modulation signals to the fourth trunk,
wherein the sum of a length of a connecting line between the first driver circuit and the first trunk, the first path length, and a length of a connecting line between the third driver circuit and the third trunk and the sum of a length of a connecting line between the second driver circuit and the second trunk, the second path length, and a length of a connecting line between the fourth driver circuit and the fourth trunk are the same.

9. The liquid crystal display device according to claim 1,
wherein a scanning signal line in a first line of the first region is scanned one or a plurality of horizontal scanning periods before or after a scanning signal line in a first line of the second region.

10. (canceled)

11. The liquid crystal display device according to claim 4, further comprising:
a fifth trunk to which holding capacitance wires that form capacitors along with the pixel electrodes in the first region and that forms capacitors along with the pixel electrodes in the second region are connected.

12. The liquid crystal display device according to claim 1,
wherein two scanning signal lines in the first region and two scanning signal lines in the second region are simultaneously scanned.
